(19) United States
(12) Patent Application Publication
(10) Pub. No.: US 2012/0213479 A1
(43) Pub. Date: Aug. 23, 2012

(54) OPTICAL CONNECTOR HAVING IMPROVED SHUTTER MECHANISM

(75) Inventor: YU ZHU, Shenzhen (CN)

(73) Assignee: HON HAI PRECISION INDUSTRY CO., LTD., New Taipei (TW)

(21) Appl. No.: 13/286,232

(22) Filed: Nov. 1, 2011

(30) Foreign Application Priority Data
Feb. 23, 2011 (CN) 201110043752.2

(51) Int. Cl. G02B 6/36

(52) U.S. Cl. 385/76

(57) ABSTRACT

An optical connector includes an insulative housing defining a mating space having a bottom, a receiving space and a through hole communicating the mating space with the receiving space via the bottom. An optical component is retained in the receiving space. A shutter mechanism is movably received in the mating space. A spring is retained in the housing and biasing the shutter mechanism. The shutter mechanism includes a base portion supported on the bottom and a shield portion covering the through hole, the shutter mechanism is moveable between a full open position for fully exposing the opening to the exterior, and a full closed position for fully covering the through hole.

### BACKGROUND OF THE INVENTION

1. Field of the Invention

The present invention relates to an optical connector, and more particularly to an optical connector having an improved shutter mechanism for preventing dust from entering into the optical connector.

2. Description of Related Art

U.S. Pat. No. 7,186,034 issued to Hu on Mar. 6, 2007 discloses an optical connector. The optical connector includes an insulative housing, an optical component retained in the insulative housing, a spring and a shutter mechanism which is pivotally assembled to the insulative housing. The insulative housing includes a top wall, an opposite bottom wall, two opposite side walls to commonly define a receiving space. The spring abuts against the shutter mechanism so that the shutter mechanism is located in a closed position. The shutter mechanism includes a base portion and a pair of pivot shafts extending outwardly from opposite sides of the base portion. The side walls of the housing define two shaft holes to receive the pivot shafts of the shutter mechanism. When a complementary connector mates with the optical connector, an optical plug which presses against the shutter mechanism is easy to damage. In the meantime, dust will enter into the receiving space.

Hence, an optical connector having an improved shutter mechanism is desired.

### BRIEF SUMMARY OF THE INVENTION

The present invention provides an optical connector including an insulative housing defining a mating space having a bottom, a receiving space and a through hole communicating the mating space with the receiving space via the bottom. An optical component is retained in the receiving space. A shutter mechanism is movably received in the mating space. A spring is retained in the housing and biasing the shutter mechanism. The shutter mechanism includes a base portion supported on the bottom and a shield portion covering the through hole, the shutter mechanism is moveable between a full open position for fully exposing the opening to the exterior, and a full closed position for fully covering the through hole.

Other objects, advantages and novel features of the invention will become more apparent from the following detailed description when taken in conjunction with the accompanying drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an optical connector in accordance with an embodiment of the present invention;

FIG. 2 is a perspective view of the optical connector as shown in FIG. 1, taken from another aspect;

FIG. 3 is an exploded view of the optical connector as shown in FIG. 1;

FIG. 4 is a cross sectional view of the optical connector, taken along line 4-4 in FIG. 1;

FIG. 5 is a cross sectional view of the optical connector, the shutter mechanism in an opened position;

FIG. 6 is a perspective view of the optical connector, the shutter mechanism in a closed position;

FIG. 7 is a perspective view of the optical connector, the shutter mechanism in an opened position;

FIG. 8 is a perspective view of an insulative housing of the optical connector; and

FIG. 9 is a perspective view of a shutter mechanism of the optical connector.

### DETAILED DESCRIPTION OF THE PREFERRED EMBODIMENTS

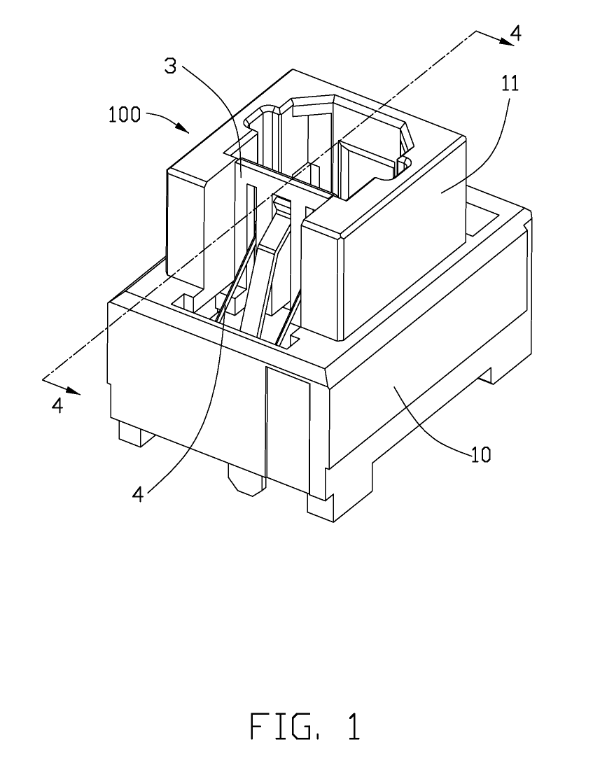

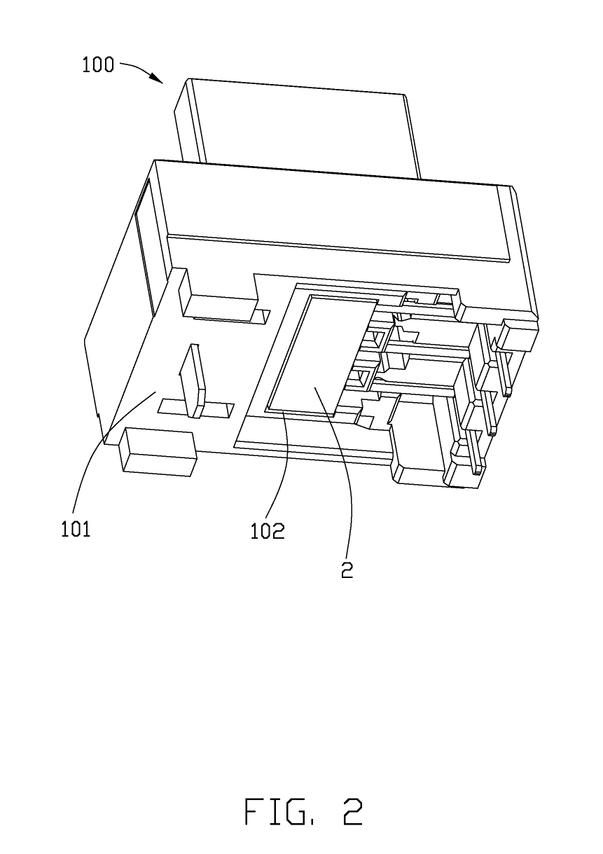

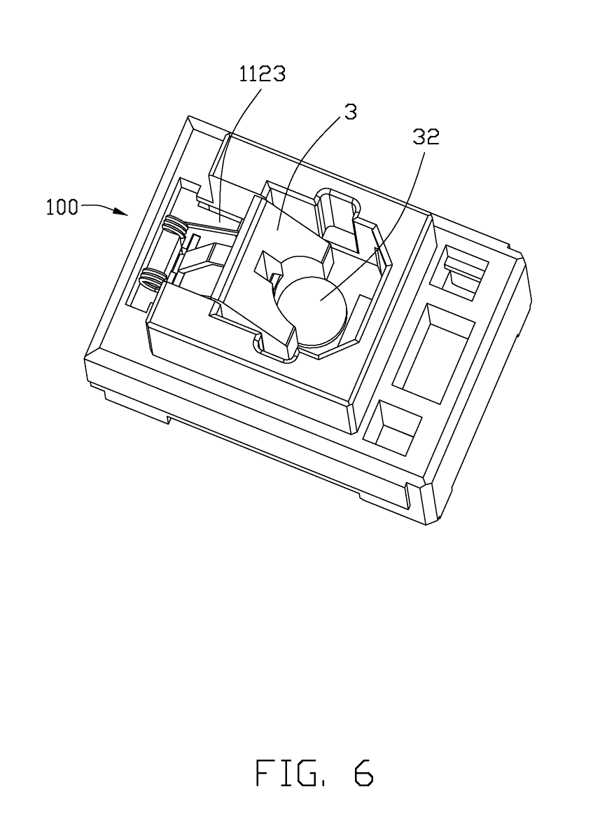

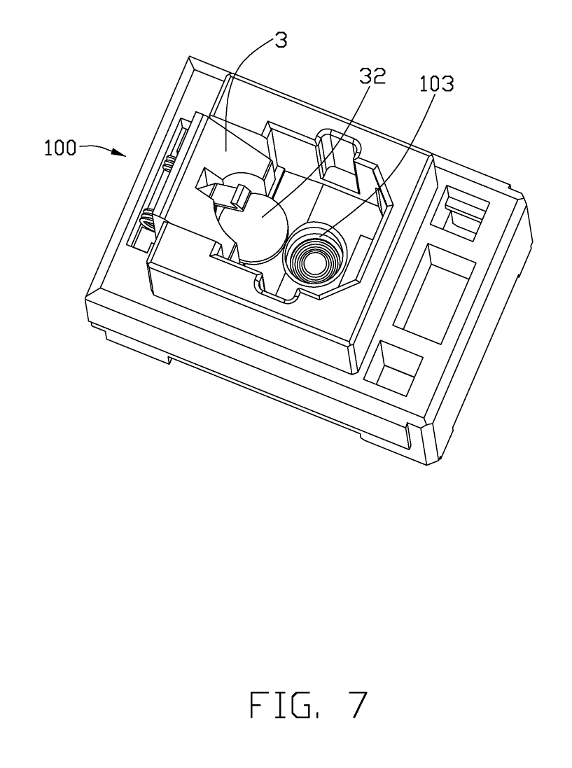

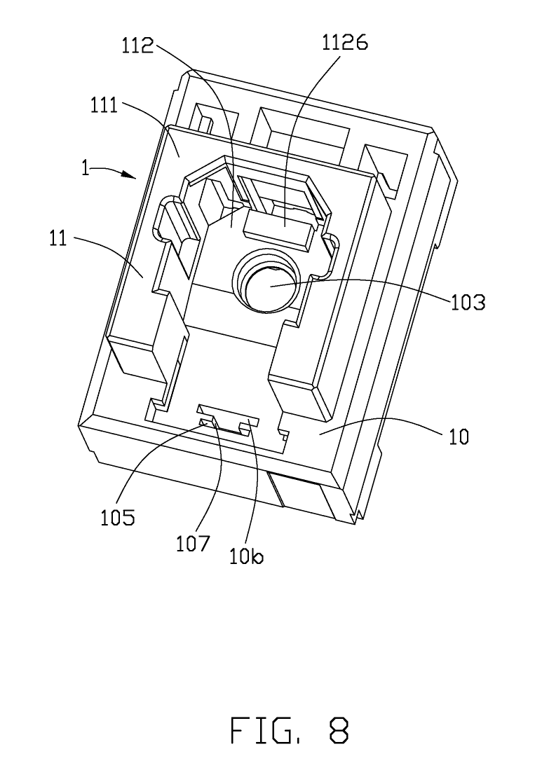

Reference will now be made to the drawing figures to describe the preferred embodiment of the present invention in detail. FIGS. 1 to 8 illustrate an optical connector 100 in accordance with an embodiment of the present invention. The optical connector 100 includes an insulative housing 1, an optical component 2 mounted to the insulative housing 1, a shutter mechanism 3 assembled to the insulative housing 1 and a spring 4 retained in the housing 1.

Referring to FIGS. 1, 3 and 8, the insulative housing 1 is rectangular shaped and includes a body portion 10 and a mating portion 11 upwardly extending from the body portion 10. The body portion 10 defines a mounting surface 101 facing a printed circuit board (not shown) and the mating portion 11 defines a mating surface 111 opposite to the mounting surface 101. The insulative housing 1 defines a mating space 112 in the mating portion and orienting through the mating surface 111, a receiving space 102 formed in the body portion and through the mounting surface 101 and a through hole 103 communicating the mating space 112 with the receiving space 102. The optical component 2 is received in the receiving space 102. The shutter mechanism 3 is located in the mating space 112. The insulative housing 1 includes a bottom 1121 and peripheral walls 1122 perpendicularly extending from the bottom 1121. The peripheral walls 1122 define an opening 1123 which communicates with the mating space 112.

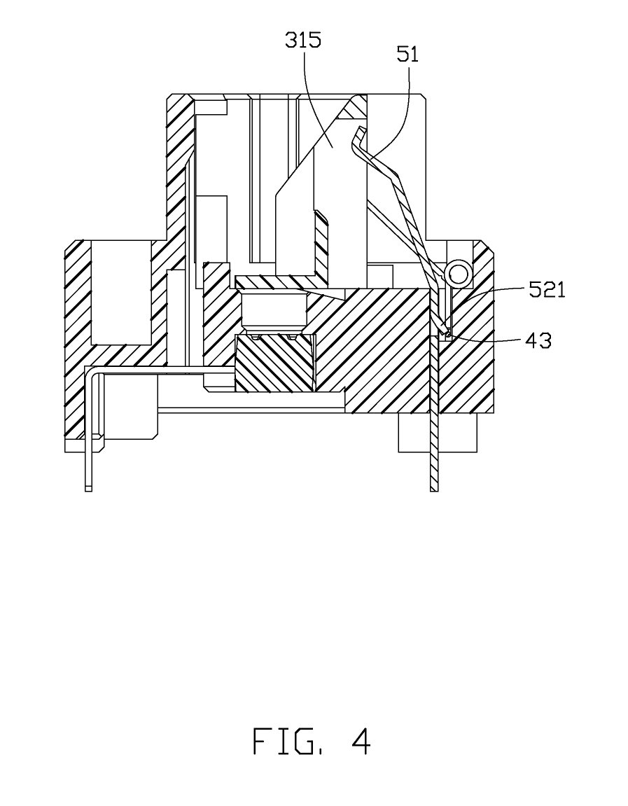

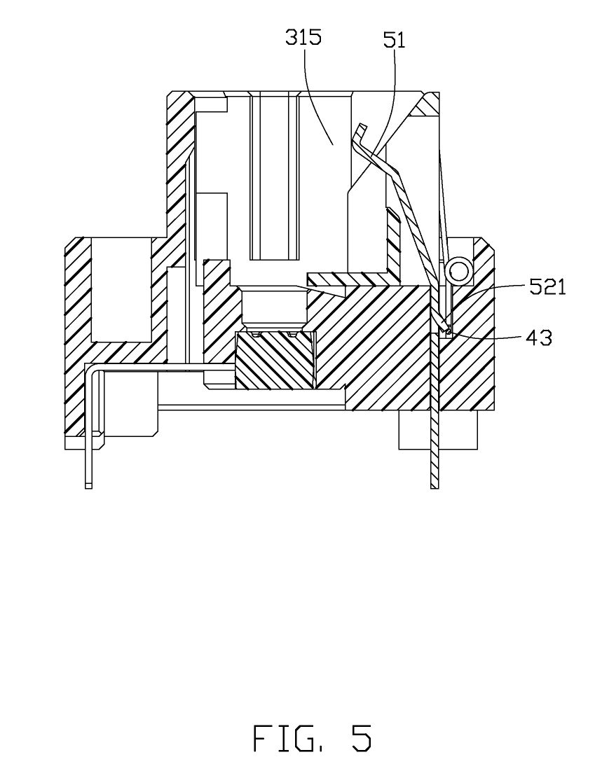

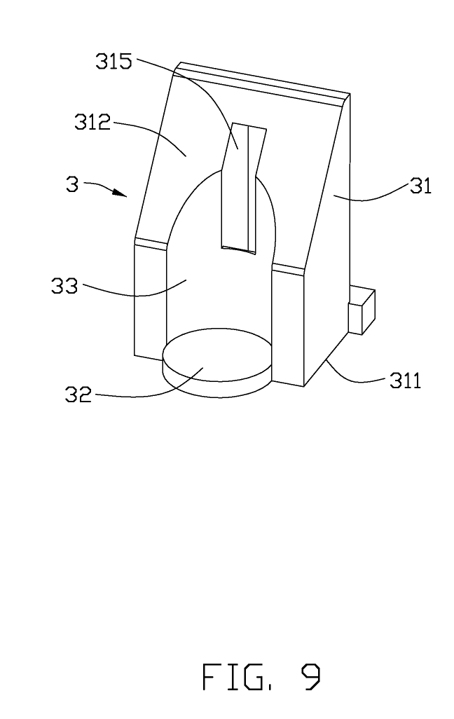

Referring to FIG. 9, the shutter mechanism 3 includes a base portion 31 seated upon the bottom 1121 of the mating space 112 and a shield portion 32 covering the through hole 103. The base portion 31 defines a horizontal bottom face 311 abutting against the bottom wall 1121 and a mating face 312 opposite to the bottom face 311. The mating face 312 obliquely inclines toward the bottom face 311. Before the optical connector 100 couples with a complementary connector (not shown), the shutter mechanism 3 is located in a closed position. Referring to FIG. 4, at this position the shield portion 32 fully covers the through hole 103 to achieve better dustproof function. During the engagement process, the complementary connector presses against the mating face 312 and the shutter mechanism 3 outwardly moves through the opening 1123 accordingly so that the through hole 103 is exposed. Referring to FIG. 5, at this position the shutter mechanism 3 is located in an opened position. Thus an optical plug (not shown) of the complementary connector enters into the through hole 103 and couples with the optical component 2.

Referring to FIG. 9, the shutter mechanism 3 further includes a receiving room 33 which is formed in the mating face 312 and located above the shield portion 32. Furthermore, the receiving room 33 communicates with the mating space 112. Thus, during the engagement process, the optical head is received in the receiving room 33 to protect the optical head from damage.

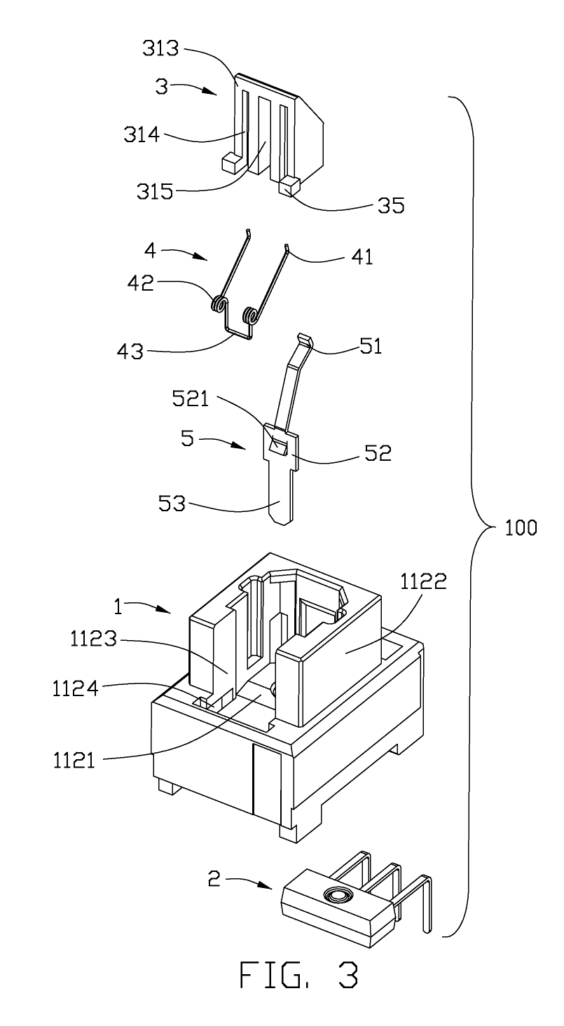

Referring to FIGS. 3 to 8, the spring 4 includes a pair of helix portions 42, a linking portion 43 adapted for connecting the helix portions 42 and two biasing portions 41. The bottom 1121 of the insulative housing 1 further defines a first slot 105 to retain the linking portion 43 of the spring 4. The first slot 105 is located outside the opening 1123 of the peripheral walls 1122. The two helix portions 42 are supported by the sidewalls of the first slot 105. The shutter mechanism 3 defines a rear face 313 opposite to the receiving room 33. The rear face 313 further defines a pair of restricting slots 314 for receiving the corresponding biasing portions 41. The biasing portions 41 provide a spring force to the shutter mechanism 3.

Referring to FIGS. 3 and 4, the optical connector 100 further includes a latch member 5 secured in the insulative housing 1. The bottom 1121 of the insulative housing 1 further defines a second slot 106 that communicates with the first slot 105 through a third slot 107. The latch member 5 is secured in the second slot 106. The shutter mechanism 3 further defines a slot 315 that runs through the mating and rear faces 312, 313 and communicates with the receiving room 33. The latch member 5 includes a latch portion 51 extending into the slot 315, a retention portion 52 secured in the second slot 106 and a tail portion 53 extending beyond the mounting surface 101. When the optical connector engages with the corresponding connector, the latch portion 51 of the latch member 5 fastens a latch structure of the corresponding connector. The retention portion 52 further defines a tab 521 extending through the third slot 107 and abutting against the linking portion 43 of the spring 4 so as to retain the spring 4. The shutter mechanism 3 further comprises a pair of guide portions 35 unitarily formed at two sides of the base portion 31. A pair of guide slots 1124 is recessed in two sidewalls of the opening 1123. When the optical connector 100 engages with the corresponding connector, the guide portions 35 of the shutter mechanism 3 slide along the guide slots 1124. A protrusion 1126 projects upwardly from the bottom 1121 and is adjacent to the through hole 103 to limit the corresponding connector.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. An optical connector comprising:
an insulative housing defining a mating space having a bottom, a receiving space and a through hole communicating the mating space with the receiving space via the bottom;
an optical component retained in the receiving space;
a shutter mechanism movably received in the mating space; and
a spring retained in the housing and biasing the shutter mechanism;
wherein the shutter mechanism comprises a base portion supported on the bottom and a shield portion covering the through hole, the shutter mechanism is moveable between a full open position for fully exposing the opening to the exterior, and a full closed position for fully covering the through hole.

2. The optical connector as claimed in claim 1, wherein the mating space has peripheral walls upwardly extending from the bottom, the peripheral walls define an opening communicating with the mating space, the shutter mechanism defines a mating face obliquely inclining toward the shield portion, when a complementary connector urges the mating face, the shutter mechanism moves outwardly through the opening.

3. The optical connector as claimed in claim 2, wherein the shutter mechanism further defines a receiving room formed in the mating face and located above the shield portion.

4. The optical connector as claimed in claim 3, wherein the shutter mechanism defines a rear face opposite to the receiving room, the spring biases the rear face.

5. The optical connector as claimed in claim 4, wherein the rear face of the shutter mechanism defines two restraint slots, the spring defines a pair of biasing portions that are limited in the restraint slots.

6. The optical connector as claimed in claim 5, wherein a pair of guide slots is recessed in two sidewalls of the opening, the shutter mechanism further comprises a pair of guide portions unitarily formed at two sides of the base portion and movably received in the guide slots.

7. The optical connector as claimed in claim 6, further comprising a latch member secured in the insulative housing, the shutter mechanism defining a slot that runs through the mating and rear faces and communicates with the receiving room, the latch member including a latch portion extending into the slot.

8. The optical connector as claimed in claim 1, wherein the spring includes a pair of helix portions, a linking portion adapted for connecting the helix portions and two biasing portions, the bottom wall of the insulative housing further defines a first slot to retain the linking portion of the spring.

9. A optical connector comprising:
an insulative housing having a mating face defining a mating space and a mounting face defining a receiving space, a through hole communicating the mating space with the receiving space;
an optical component retained in the receiving space; and
a latch member retained in the insulative housing and comprising a latch portion extending into the mating space, when the optical connector engages with a complementary connector, the latch portion mates with a latch structure of the complementary connector.
